(19) United States
(12) Patent Application Publication
(10) Pub. No.: US 2025/0310354 A1
(43) Pub. Date: Oct. 2, 2025

(54) RULES PROCESSING SYSTEM

(71) Applicant: Sophos Limited, Abingdon (GB)

(72) Inventors: Nicholas Daniel TenBrink, Scandia, MN (US); Christopher Adam Benninger, Victoria (CA); Anish Niranjan Hemmady, Indianapolis, IN (US); Patrick Michael Owens, Burnaby (CA); Peter Chongjin Kim, Vancouver (CA); Anthony Wade Gruetzmacher, La Marque, TX (US); Faisal Ibrahim Mudhir, Birmingham, AL (US); Benjamin Edward Rood, Lacey, WA (US); Tony Richard Pelletier, Manchester, NH (US)

(21) Appl. No.: 18/763,507

(22) Filed: Jul. 3, 2024

Related U.S. Application Data
(60) Provisional application No. 63/572,691, filed on Apr. 1, 2024.

(51) Int. Cl. H04L 9/40

(52) U.S. Cl. CPC H04L 63/1416

(57) ABSTRACT

A rule processing system uses rule objects that self-define contexts where they apply. When an event is received, a rule set for evaluating the event can be creating by filtering a group of rule objects according to whether the detection rules contained therein are applicable to a context for the event. Each rule object may also contain refinement rules that further define how a detection is reported when a detection is generated by the detection rule(s) contained in the rule object. This architecture can significantly reduce the processing time required for performing detections in heterogenous computing environments such as a large enterprise network, where a large rule set must be applied to a high volume of events having different types and sources.

### RELATED APPLICATIONS

This application claims priority to U.S. Prov. App. No. 63/572,691, filed on Apr. 1, 2024, the entire contents of which are hereby incorporated by reference.

### BACKGROUND

There remains a need for a rule processing engine to efficiently manage the increasingly complex rule sets used in environments such as threat detection, where rule sets are generally processed sequentially, but many rules in the rule set are specific to a specific context such as a particular document type, operating system, hardware platform, and the like.

### SUMMARY

A rule processing system uses rule objects that self-define contexts where they apply. When an event is received, a rule set for evaluating the event can be creating by filtering a group of rule objects according to whether the detection rules contained therein are applicable to a context for the event. Each rule object may also contain refinement rules that further define how a detection is reported when a detection is generated by the detection rule(s) contained in the rule object. This architecture can significantly reduce the processing time required for performing detections in heterogenous computing environments such as a large enterprise network, where a large rule set must be applied to a high volume of events having different types and sources.

In one aspect, there is disclosed herein a computer program product comprising computer executable code embodied in a non-transitory computer readable medium that, when executing on one or more computing devices associated with an enterprise network, causes the one or more computing devices to perform the steps of: storing a plurality of rule objects for processing security events in an event stream of the enterprise network, wherein each one of the plurality of rule objects includes: one or more detection rules for detecting malicious activities, and one or more selection criteria for determining, based on a platform configuration for a source of a security event, whether to load the one or more detection rules of the one of the plurality of rule objects for use by an event processing service to evaluate the security event for potential malware; receiving one of the security events in the event stream at the event processing service as a security event object; determining the platform configuration for the source of the security event object; selecting a group of rule objects including one or more of the plurality of rule objects based on the platform configuration for the source of the security event object; applying each of the one or more detection rules from the group of rule objects to the security event object; in response to identifying one of the malicious activities in the security event object with the one or more detection rules from the group of rule objects, generating a notification of malicious activity; and transmitting the notification to a threat management facility for the enterprise network.

The platform configuration may include an operating system configuration for the source of the security event. The platform configuration may include a software configuration for the source of the security event. The source of the security event may include a compute instance associated with the enterprise network.

In another aspect, a method disclosed herein includes storing a plurality of rule objects for processing events in an event stream of an enterprise network, wherein each one of the plurality of rule objects may include: one or more detection rules for detecting activities, and one or more load rules for determining whether to apply the one or more detection rules to the event stream; receiving one of the events as an event object in the event stream; determining the type of the event object; selecting a first rule object from the plurality of rule objects based on the type of the event object; applying a first detection rule from the first rule object to the event object; and in response to identifying one of the activities in the event object with the first detection rule from the first rule object, initiating a response to the one of the activities.

The type of the event object may include a source of the event object. The source of the event object may include a compute instance associated with the enterprise network. The source of the event object may include a firewall associated with the enterprise network. The type of the event object may include a platform configuration for a source of the event object. The platform configuration may include an operating system configuration for the source of the event object. The platform configuration may include a software configuration for the source of the event object. The one of the activities may include a malicious activity, and initiating the response may include initiating a remediation of the malicious activity. Initiating the remediation may include transmitting a notification of a malicious activity to a threat management facility for the enterprise network. Initiating the remediation may include initiating a threat response to the malicious activity by a source of the event object. Initiating the remediation may include at least one of quarantining a source of the event object, updating security software for the source of the event object, performing a scan of the source of the event object, and requesting data from a data recorder for a local security agent executing on the source of the event object. The event may include a JSON object. The method may include selecting a group of two or more of the rule objects from the plurality of rule objects based on the type of the event object; and applying one or more detection rules from the group of two or more of the rule objects to the event object.

In another aspect, there is disclosed herein a system for processing security events in an event stream for an enterprise network. The system may include a database and a rule processing engine. The database may store a plurality of rule objects for processing the security events in the event stream, wherein each one of the plurality of rule objects includes: one or more detection rules for detecting malicious activities, and one or more selection criteria for determining, based on a type of a security event, whether to apply the one or more detection rules of the rule object to the security event. The rule processing engine may be configured by computer executable code stored in a non-transitory computer readable medium that, when executing on one or more processors, causes the rule processing engine to perform the steps of: receiving one of the security events as a security event object in the event stream, determining the type of the security event object, selecting a group of rule objects including one or more of the plurality of rule objects stored in the database based on the type, applying each of the one or more detection rules for each rule object in the group of rule objects to the security event object,
in response to at least one of the detection rules identifying one of the malicious activities, generating a notification of a detection of malicious activity, and transmitting the notification to a threat management facility for the enterprise network.

The event stream may include a plurality of security event objects from a plurality of compute instances in the enterprise network managed by the threat management facility. Each of the plurality of rule objects may include one or more refinement rules that provide instructions for additional processing of one of the security events after the detection of a malicious activity may be made based on the at least one of the detection rules.

### BRIEF DESCRIPTION OF THE DRAWINGS

The foregoing and other objects, features, and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 depicts a block diagram of a threat management system.

FIG. 2 shows a system for enterprise network threat detection.

FIG. 3 illustrates a threat management system.

FIG. 4 shows a threat management facility in a zero trust network access (ZTNA) environment.

FIG. 5 shows a system for event monitoring and response.

FIG. 6 shows a method for processing rules.

FIG. 7 illustrates a workflow for a rule processing engine.

FIG. 8 illustrates a rule object.

### DETAILED DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “of” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

It should also be understood that endpoints, devices, compute instances, or the like that are referred to as “within” an enterprise network may also be “associated with” the enterprise network, e.g., where such assets are outside an enterprise gateway but nonetheless managed by or in communication with a threat management facility or other centralized security platform for the enterprise network. Thus, any description referring to an asset within the enterprise network should be understood to contemplate a similar asset associated with the enterprise network regardless of location in a network environment unless a different meaning is explicitly provided or otherwise clear from the context.

As described herein, a threat management system may use a Sensor, Events, Analytics, and Response (SEAR) approach to protect enterprises against cybersecurity threats.

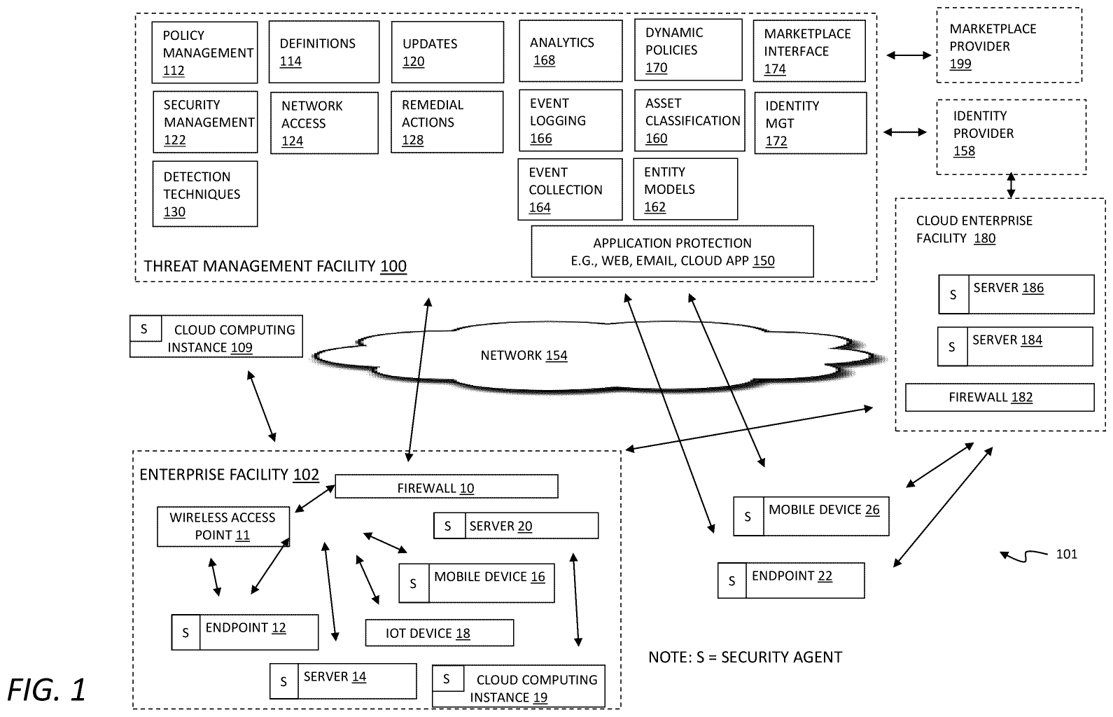

FIG. 1 depicts a block diagram of a threat management system 101 providing protection against a plurality of threats, such as malware, viruses, spyware, cryptoware, adware, Trojans, spam, intrusion, policy abuse, improper configuration, vulnerabilities, improper access, uncontrolled access, and more. A threat management facility 100 may communicate with, coordinate, and control operation of security functionality at different control points, layers, and levels within the threat management system 101. A number of capabilities may be provided by a threat management facility 100, with an overall goal to intelligently use the breadth and depth of information that is available about the operation and activity of compute instances and networks as well as a variety of available controls. Another overall goal is to provide protection needed by an organization that is dynamic and able to adapt to changes in compute instances and new threats. In embodiments, the threat management facility 100 may provide protection from a variety of threats to a variety of compute instances in a variety of locations and network configurations.

Just as one example, users of the threat management facility 100 may define and enforce policies that control access to and use of compute instances, networks and data. Administrators may update policies such as by designating authorized users and conditions for use and access. The threat management facility 100 may update and enforce those policies at various levels of control that are available, such as by directing compute instances to control the network traffic that is allowed to traverse firewalls and wireless access points, applications, and data available from servers, applications and data permitted to be accessed by endpoints, and network resources and data permitted to be run and used by endpoints. The threat management facility 100 may provide many different services, and policy management may be offered as one of the services.

Turning to a description of certain capabilities and components of the threat management system 101, an exemplary enterprise facility 102 may be or may include any networked computer-based infrastructure. For example, the enterprise facility 102 may be corporate, commercial, organizational, educational, governmental, or the like. As home networks get more complicated and include more compute instances at home and in the cloud, an enterprise facility 102 may also or instead include a personal network such as a home or a group of homes. A computer network for the enterprise facility 102 may be distributed amongst a plurality of physical premises such as buildings on a campus and located in one or in a plurality of geographical locations. The configuration of the enterprise facility as shown is merely exemplary, and it will be understood that there may be any number of compute instances, less or more of each type of compute instances, and other types of compute instances. As shown, the exemplary enterprise facility includes a firewall 10, a wireless access point 11, an endpoint 12, a server 14, a mobile device 16, an appliance or IOT device 18, a cloud computing instance 19, and a server 20. Again, the compute instances 10-20 depicted are exemplary, and there may be any number or types of compute instances 10-20 in a given enterprise facility. For example, in addition to the elements depicted in the enterprise facility 102, there may be one or more gateways, bridges, wired networks, wireless networks, virtual private networks, other compute instances, and so on.

The threat management facility 100 may include certain facilities, such as a policy management facility 112, security management facility 122, update facility 120, definitions facility 114, network access rules facility 124, remedial action facility 128, detection techniques facility 130, application protection facility 150, asset classification facility 160, entity model facility 162, event collection facility 164, event logging facility 166, analytics facility 168, dynamic policy facility 170, identity management facility 172, and marketplace management facility 174, as well as other facilities. For example, there may be a testing facility, a threat research facility, and other facilities. It should be understood that the threat management facility 100 may be implemented in whole or in part on a number of different compute instances, with some parts of the threat management facility on different compute instances in different locations. For example, the threat management facility 100 may include, or may be connected to a security agent S such as a local security agent deployed on one or more other entities within the threat management system 101. The facilities of the threat management facility 100, and/or a security agent S therefore, may be deployed on the same physical hardware or logical resource as a gateway for an enterprise facility 102, a firewall 10, or wireless access point 11. Some or all of one or more of the facilities may be provided on one or more cloud servers that are operated by the enterprise or by a security service provider, such as the cloud computing instance 109.

In embodiments, a marketplace provider 199 may make available one or more additional facilities to the enterprise facility 102 via the threat management facility 100. The marketplace provider may communicate with the threat management facility 100 via the marketplace management facility 174 to provide additional functionality or capabilities to the threat management facility 100 and compute instances 10-26. As non-limiting examples, the marketplace provider 199 may be a third-party information provider, such as a physical security event provider; the marketplace provider 199 may be a system provider, such as a human resources system provider or a fraud detection system provider; the marketplace provider may be a specialized analytics provider; and so on. The marketplace provider 199, with appropriate permissions and authorization, may receive and send events, observations, inferences, controls, convictions, policy violations, or other information to the threat management facility. For example, the marketplace provider 199 may subscribe to and receive certain events, and in response, based on the received events and other events available to the marketplace provider 199, send inferences to the marketplace interface, and in turn to the analytics facility 168, which in turn may be used by the security management facility 122.

The identity provider 158 may be any remote identity management system or the like configured to communicate with an identity management facility 172, e.g., to confirm identity of a user as well as provide or receive other information about users that may be useful to protect against threats. In general, the identity provider may be any system or entity that creates, maintains, and manages identity information for principals while providing authentication services to relying party applications, e.g., within a federation or distributed network. The identity provider may, for example, offer user authentication as a service, where other applications, such as web applications, outsource the user authentication step to a trusted identity provider.

In embodiments, the identity provider 158 may provide user identity information, such as multi-factor authentication, to a SaaS application. Centralized identity providers such as Microsoft Azure, may be used by an enterprise facility instead of maintaining separate identity information for each application or group of applications, and as a centralized point for integrating multifactor authentication. In embodiments, the identity management facility 172 may communicate hygiene, or security risk information, to the identity provider 158. The identity management facility 172 may determine a risk score for a user based on the events, observations, and inferences about that user and the compute instances associated with the user. If a user is perceived as risky, the identity management facility 172 can inform the identity provider 158, and the identity provider 158 may take steps to address the potential risk, such as to confirm the identity of the user, confirm that the user has approved the SaaS application access, remediate the user's system, or such other steps as may be useful.

In embodiments, threat protection provided by the threat management facility 100 may extend beyond the network boundaries of the enterprise facility 102 to include clients (or client facilities) such as an endpoint 22 outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop. While threats may come from a variety of sources, such as from network threats, physical proximity threats, secondary location threats, the compute instances 10-26 may be protected from threats even when a compute instance 10-26 is not connected to the enterprise facility 102 network, such as when compute instances 22, 26 use a network that is outside of the enterprise facility 102 and separated from the enterprise facility 102, e.g., by a gateway, a public network, and so forth.

In embodiments, aspects of the threat management facility 100 may be provided as a stand-alone solution. In other embodiments, aspects of the threat management facility 100 may be integrated into a third-party product. An application programming interface (e.g., a source code interface) may be provided such that aspects of the threat management facility 100 may be integrated into or used by or with other applications. Alternatively, the threat management facility may offer protection indirectly, through a third-party product, where an enterprise may subscribe to services through the third-party product, and threat protection to the enterprise may be provided by the threat management facility 100 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In embodiments, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in the security agent of an endpoint 12, in a wireless access point 11 or firewall 10, as part of an application protection facility 150 provided by the cloud, and so on.

In an embodiment, the security management facility 122 may provide for email security and control, for example to target spam, viruses, spyware, and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of an application protection facility 150 provided by the cloud, and so on.

In an embodiment, security management facility 122 may provide for web security and control, for example, to detect or block viruses, spyware, malware, unwanted applications, help control web browsing, and the like, which may provide comprehensive web access control enabling safe, productive web browsing. Web security and control may provide Internet use policies, reporting on suspect compute instances, security and content filtering, active monitoring of network traffic, URI filtering, and the like. Aspects of the web security and control may be provided, for example, in the security agent of an endpoint 12, in a wireless access point 11 or firewall 10, as part of an application protection facility 150 provided by the cloud, and so on.

In an embodiment, the security management facility 122 may provide for network access control, which generally controls access to and use of network connections. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. In embodiments, a VPN may be treated in the same manner as a physical network. Aspects of network access control may be provided, for example, in the security agent of an endpoint 12, in a wireless access point 11 or firewall 10, as part of an application protection facility 150 provided by the cloud, e.g., from the threat management facility 100 or other network resource(s).

In an embodiment, the security management facility 122 may provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of an application protection facility 150 provided by the cloud, and so on.

In an embodiment, the security management facility 122 may provide for reputation filtering, which may target or identify sources of known malware. For instance, reputation filtering may include lists of URIs of known sources of malware or known suspicious IP addresses, code authors, code signers, or domains, that when detected may invoke an action by the threat management facility 100. Based on reputation, potential threat sources may be blocked, quarantined, restricted, monitored, or some combination of these, before an exchange of data can be made. Aspects of reputation filtering may be provided, for example, in the security agent of an endpoint 12, in a wireless access point 11 or firewall 10, as part of an application protection facility 150 provided by the cloud, and so on. In embodiments, some reputation information may be stored on a compute instance 10-26, and other reputation data available through cloud lookups to an application protection lookup database, such as may be provided by an application protection facility 150.

In embodiments, information may be sent from the enterprise facility 102 to a third party, such as a security vendor, or the like, which may lead to improved performance of the threat management facility 100. In general, feedback may be useful for any aspect of threat detection. For example, the types, times, and number of virus interactions that an enterprise facility 102 experiences may provide useful information for the preventions of future virus threats. Feedback may also be associated with behaviors of individuals within the enterprise, such as being associated with most common violations of policy, network access, unauthorized application loading, unauthorized external device use, and the like. In embodiments, feedback may enable the evaluation or profiling of client actions that are violations of policy that may provide a predictive model for the improvement of enterprise policies.

An update management facility 90 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In embodiments, updates may be provided to a network for the enterprise facility 102, where one or more compute instances on the network of the enterprise facility 102 may distribute updates to other compute instances.

The threat management facility 100 may include a policy management facility 112 that manages rules or policies for the enterprise facility 102. Exemplary rules include access permissions associated with networks, applications, compute instances, users, content, data, and the like. The policy management facility 112 may use a database, a text file, other data store, or a combination to store policies. In an embodiment, a policy database may include a block list, a blacklist, an allowed list, a whitelist, and more. As a few non-limiting examples, policies may include a list of external network locations/applications for the enterprise facility 102 that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. Exemplary policies may be defined for an enterprise facility, application type, subset of application capabilities, organization hierarchy, compute instance type, user type, network location, time of day, connection type, or any other suitable definition. Policies may be maintained through the threat management facility 100, in association with a third party, or the like. For example, a policy may restrict instant messaging (IM) activity by limiting such activity to support personnel when communicating with customers. More generally, this may allow communication for departments as necessary or helpful for department functions, but may otherwise preserve network bandwidth for other activities by restricting the use of IM to personnel that need access for a specific purpose. In an embodiment, the policy management facility 112 may be a stand-alone application, or may be part of the threat management facility 100, the cloud enterprise facility 180, the enterprise facility, or any suitable combination of these.

The policy management facility 112 may include dynamic policies that use contextual or other information to make security decisions. As described herein, the dynamic policy facility 170 may generate policies dynamically based on observations and inferences made by the analytics facility. The dynamic policies generated by the dynamic policy facility 170 may be provided by the policy management facility 112 to the security management facility 122 for enforcement.

In embodiments, the threat management facility 100 may provide configuration management as an aspect of the policy management facility 112, the security management facility 122, or some combination. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 9, 14, 18, a version of a client firewall may be required to be running and installed. If the required version is installed but in a disabled state, the policy violation may prevent access to data or network resources. A remediation may be to enable the firewall. In another example, a configuration policy may disallow the use of USB disks, and the policy management facility 112 may require a configuration that turns off USB drive access via a registry key of a compute instance. Aspects of configuration management may be provided, for example, in the security agent of an endpoint 12, in a wireless access point 11 or firewall 10, as part of an application protection facility 150 provided by the cloud, or any combination of these.

In embodiments, the threat management facility 100 may also provide for the isolation or removal of certain applications that are not desired or may interfere with the operation of a compute instance 10-26 or the threat management facility 100, even if such application is not malware per se. The operation of such products may be considered a configuration violation. The removal of such products may be initiated automatically whenever such products are detected, or access to data and network resources may be restricted when they are installed and running. In the case where such applications are services which are provided indirectly through a third-party product, the applicable application or processes may be suspended until action is taken to remove or disable the third-party product.

The policy management facility 112 may also require update management (e.g., as provided by the update facility 120). Update management for the security facility 92 and policy management facility 112 may be provided directly by the threat management facility 100, or, for example, by a hosted system. In embodiments, the threat management facility 100 may also provide for patch management, where a patch may be an update to an operating system, an application, a system tool, or the like, where one of the reasons for the patch is to reduce vulnerability to threats.

In embodiments, the security facility 92 and policy management facility 112 may push information to the enterprise facility 102 network and/or the compute instances 10-26, the enterprise facility 102 network and/or compute instances 10-26 may pull information from the security facility 92 and policy management facility 112, or there may be a combination of pushing and pulling of information. For example, the enterprise facility 102 network and/or compute instances 10-26 may pull update information from the security facility 92 and policy management facility 112 via the update facility 120, an update request may be based on a time period, by a certain time, by a date, on demand, or the like. In another example, the security facility 92 and policy management facility 112 may push the information to the network and/or compute instances 10-26 of enterprise facility 102 by providing notification that there are updates available for download and/or transmitting the information. In an embodiment, the policy management facility 112 and the security facility 92 may work in concert with the update management facility 90 to provide information to the network and/or compute instances 10-26 of the enterprise facility 102. In various embodiments, policy updates, security updates and other updates may be provided by the same or different modules, which may be the same or separate from a security agent running on one of the compute instances 10-26.

As threats are identified and characterized, the definitions facility 114 of the threat management facility 100 may manage definitions used to detect and remediate threats. For example, identity definitions may be used for scanning files, applications, data streams, etc. for the determination of malicious code. Identity definitions may include instructions and data that can be parsed and acted upon for recognizing features of known or potentially malicious code. Definitions also may include, for example, code or data to be used in a classifier, such as a neural network or other classifier that may be trained using machine learning. Updated code or data may be used by the classifier to classify threats. In embodiments, the threat management facility 100 and the compute instances 10-26 may be provided with new definitions periodically to include most recent threats. Updating of definitions may be managed by the update facility 120, and may be performed upon request from one of the compute instances 10-26, upon a push, or some combination. Updates may be performed upon a time period, on demand from a device 10-26, upon determination of an important new definition or a number of definitions, and so on.

A threat research facility (not shown) may provide a continuously ongoing effort to maintain the threat protection capabilities of the threat management facility 100 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 100 may control access to the enterprise facility 102 networks. A network access facility 94 may restrict access to certain applications, networks, files, printers, servers, databases, and so on. In addition, the network access facility 94 may restrict user access under certain conditions, such as the user's location, usage history, need to know, job position, connection type, time of day, method of authentication, client-system configuration, or the like. Network access policies may be provided by the policy management facility 112, and may be developed by the enterprise facility 102, or pre-packaged by a supplier. Network access facility 94 may determine if a given compute instance 10-22 should be granted access to a requested network location, e.g., inside or outside of the enterprise facility 102. Network access facility 94 may determine if a compute instance 22, 26 such as a device outside the enterprise facility 102 may access the enterprise facility 102. For example, in some cases, the policies may require that when certain policy violations are detected, certain network access is denied. The network access facility 94 may communicate remedial actions that are necessary or helpful to bring a device back into compliance with policy as described below with respect to the remedial action facility 128. Aspects of the network access facility 94 may be provided, for example, in the security agent of the endpoint 12, in a wireless access point 11, in a firewall 10, as part of an application protection facility 150 provided by the cloud, and so on.

In an embodiment, the network access facility 94 may have access to policies that include one or more of a block list, an allowed list, an unacceptable network site database, an acceptable network site database, a network site reputation database, or the like of network access locations that may or may not be accessed by the client facility. Additionally, the network access facility 94 may use rule evaluation to parse network access requests and apply policies. The network access rule facility 94 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 100 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, MacOS, Linux, Android, iOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility may include an entity model facility 162. Entity models supported by the entity model facility 162 may be used, for example, to determine the events that are generated by assets. For example, some operating systems may provide useful information for detecting or identifying events. For examples, operating systems may provide process and usage information that is accessed through an API. As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection facility 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, cloud computing instance 19, and cloud compute instance 109. Events may range in granularity. An exemplary event may be communication of a specific packet over the network. Another exemplary event may be identification of an application that is communicating over a network.

The event logging facility 166 may be used to store events collected by the event collection facility 164. The event logging facility 166 may store collected events so that they can be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility. Observations or inferences about events may also be logged by the event logging facility 166.

When a threat or other policy violation is detected by the security management facility 122, the remedial action facility 128 may be used to remediate the threat. Remedial action may take a variety of forms, non-limiting examples including collecting additional data about the threat, terminating or modifying an ongoing process or interaction, sending a warning to a user or administrator, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 92 may take any steps or deploy any measures suitable for addressing a detection of a threat, potential threat, policy violation or other event, code or activity that might compromise security of a computing instance 10-26 or the enterprise facility 102.

A cloud enterprise facility 180 may include servers 184, 186, and a firewall 182. The servers 184, 186 on the cloud enterprise facility 180 may run one or more enterprise applications and make them available to the enterprise facilities 102 compute instances 10-26. It should be understood that there may be any number of servers 184, 186 and firewalls 182, as well as other compute instances in a given cloud enterprise facility 180.

In some implementations, the cloud enterprise facility 180 may include resources used by, but not managed by, the enterprise facility 102. For example, the threat management system 101 may include a Software-as-a-Service (SaaS) application that is used by, but not operated by, the enterprise facility 102. Exemplary commercially available SaaS applications include Salesforce, Amazon Web Services (AWS) applications, Google Apps applications, Microsoft Office 365 applications and so on. A given SaaS application may communicate with an identity provider 158 to verify user identity consistent with the requirements of the enterprise facility 102. The compute instances 10-26 may communicate with the SaaS application, and/or an unprotected server (not shown) for the SaaS application such as a web site or a third-party application through an internetwork 154 such as the Internet or any other public network, private network, or combination of these.

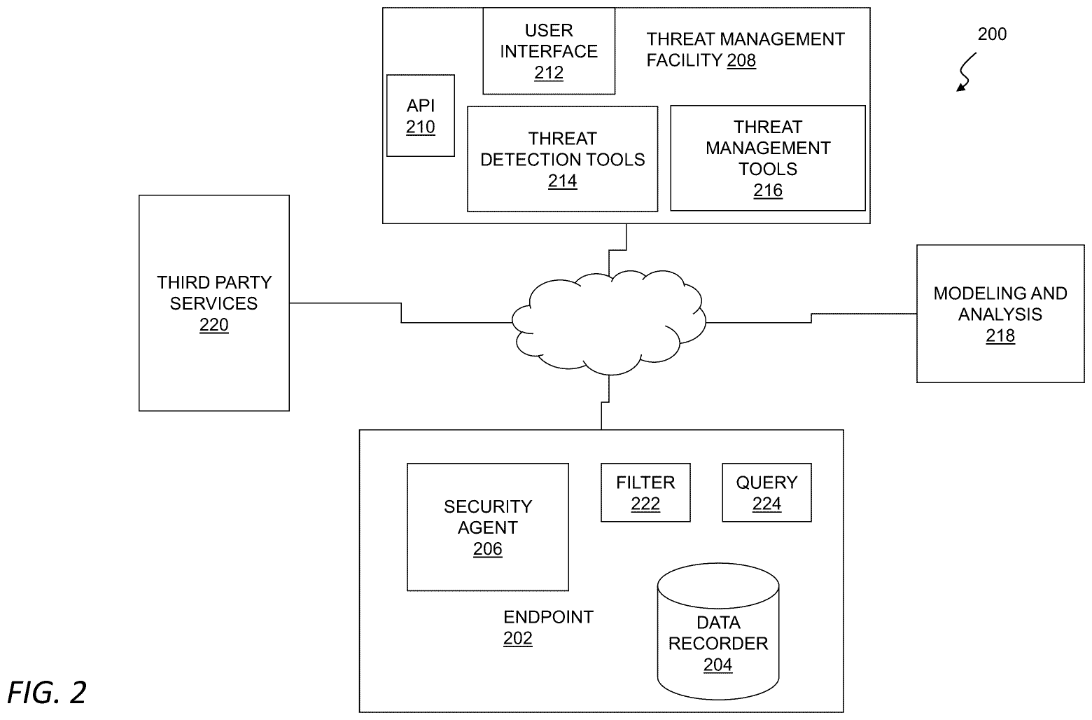

FIG. 2 shows a system 200 for enterprise network threat detection. The system 200 may use any of the various tools and techniques for threat management contemplated herein. In the system, a number of endpoints such as the endpoint 202 may log events in a data recorder 204. A local agent on the endpoint 202 such as the security agent 206 may filter this data and feeds a filtered data stream to a threat management facility 208 such as a central threat management facility or any of the other threat management facilities described herein. The threat management facility 208 can locally or globally tune filtering by local agents based on the current data stream and can query local event data recorders for additional information where necessary or helpful in threat detection or forensic analysis. The threat management facility 208 may also or instead store and deploys a number of security tools such as a web-based user interface that is supported by machine learning models to aid in the identification and assessment of potential threats by a human user. This may, for example, include machine learning analysis of new code samples, models to provide human-readable context for evaluating potential threats, and any of the other tools or techniques described herein. More generally, the threat management facility 208 may provide any of a variety of threat management tools 216 to aid in the detection, evaluation, and remediation of threats or potential threats.

The threat management facility 208 may perform a range of threat management functions such as any of those described herein. The threat management facility 208 may generally include an application programming interface 210 to third party services 220, a user interface 212 for access to threat management and network administration functions, and a number of threat detection tools 214.

In general, the application programming interface 210 may support programmatic connections with third party services 220. The application programming interface 210 may, for example, connect to Active Directory or other customer information about files, data storage, identities and user profiles, roles, access privileges and so forth. More generally the application programming interface 210 may provide a programmatic interface for customer or other third party context, information, administration and security tools, and so forth. The application programming interface 210 may also or instead provide a programmatic interface for hosted applications, identity provider integration tools or services, and so forth.

The user interface 212 may include a website or other graphical interface or the like, and may generally provide an interface for user interaction with the threat management facility 208, e.g., for threat detection, network administration, audit, configuration and so forth. This user interface 212 may generally facilitate human curation of intermediate threats as contemplated herein, e.g., by presenting intermediate threats along with other supplemental information, and providing controls for user to dispose of such intermediate threats as desired, e.g., by permitting execution or access, by denying execution or access, or by engaging in remedial measures such as sandboxing, quarantining, vaccinating, and so forth.

The threat detection tools 214 may be any of the threat detection tools, algorithms, techniques or the like described herein, or any other tools or the like useful for detecting threats or potential threats within an enterprise network. This may, for example, include signature based tools, behavioral tools, machine learning models, and so forth. In general, the threat detection tools 214 may use event data provided by endpoints within the enterprise network, as well as any other available context such as network activity, heartbeats, and so forth to detect malicious software or potentially unsafe conditions for a network or endpoints connected to the network. In one aspect, the threat detection tools 214 may usefully integrate event data from a number of endpoints (including, e.g., network components such as gateways, routers, and firewalls) for improved threat detection in the context of complex or distributed threats. The threat detection tools 214 may also or instead include tools for reporting to a separate modeling and analysis platform 218, e.g., to support further investigation of security issues, creation or refinement of threat detection models or algorithms, review and analysis of security breaches, and so forth.

The threat management tools 216 may generally be used to manage or remediate threats to the enterprise network that have been identified with the threat detection tools 214 or otherwise. Threat management tools 216 may, for example, include tools for sandboxing, quarantining, removing, or otherwise remediating or managing malicious code or malicious activity, e.g., using any of the techniques described herein.

The endpoint 202 may be any of the endpoints or other compute instances or the like described herein. This may, for example, include end-user computing devices, mobile devices, firewalls, gateways, servers, routers and any other computing devices or instances that might connect to an enterprise network. As described above, the endpoint 202 may generally include a security agent 206 that locally supports threat management on the endpoint 202, such as by monitoring for malicious activity, managing security components on the endpoint 202, maintaining policy compliance, and communicating with the threat management facility 208 to support integrated security protection as contemplated herein. The security agent 206 may, for example, coordinate instrumentation of the endpoint 202 to detect various event types involving various computing objects on the endpoint 202, and supervise logging of events in a data recorder 204. The security agent 206 may also or instead scan computing objects such as electronic communications or files, monitor behavior of computing objects such as executables, and so forth. The security agent 206 may, for example, apply signature-based or behavioral threat detection techniques, machine learning models (e.g., models developed by the modeling and analysis platform), or any other tools or the like suitable for detecting malware or potential malware on the endpoint 202.

The data recorder 204 may log events occurring on or related to the endpoint. This may, for example, include events associated with computing objects on the endpoint 202 such as file manipulations, software installations, and so forth. This may also or instead include activities directed from the endpoint 202, such as requests for content from Uniform Resource Locators or other network activity involving remote resources. The data recorder 204 may record data at any frequency and any level of granularity consistent with proper operation of the endpoint 202 in an intended or desired manner.

The endpoint 202 may include a filter 222 to manage a flow of information from the data recorder 204 to a remote resource such as the threat detection tools 214 of the threat management facility 208. In this manner, a detailed log of events may be maintained locally on each endpoint, while network resources can be conserved for reporting of a filtered event stream that contains information believed to be most relevant to threat detection. The filter 222 may also or instead be configured to report causal information that causally relates collections of events to one another. In general, the filter 222 may be configurable so that, for example, the threat management facility 208 can increase or decrease the level of reporting based on a current security status of the endpoint, a group of endpoints, the enterprise network, and the like. The level of reporting may also or instead be based on currently available network and computing resources, or any other appropriate context.

In another aspect, the endpoint 202 may include a query interface 224 so that remote resources such as the threat management facility 208 can query the data recorder 204 remotely for additional information. This may include a request for specific events, activity for specific computing objects, or events over a specific time frame, or some combination of these. Thus, for example, the threat management facility 208 may request all changes to the registry of system information for the past forty eight hours, all files opened by system processes in the past day, all network connections or network communications within the past hour, or any other parametrized request for activities monitored by the data recorder 204. In another aspect, the entire data log, or the entire log over some predetermined window of time, may be a request for further analysis at a remote resource.

It will be appreciated that communications among third party services 220, a threat management facility 208, and one or more endpoints such as the endpoint 202 may be facilitated by using consistent naming conventions across products and machines. For example, the system 200 may usefully implement globally unique device identifiers, user identifiers, application identifiers, data identifiers, Uniform Resource Locators, network flows, and files. The system may also or instead use tuples to uniquely identify communications or network connections based on, e.g., source and destination addresses and so forth.

According to the foregoing, a system disclosed herein includes an enterprise network, and endpoint coupled to the enterprise network, and a threat management facility coupled in a communicating relationship with the endpoint and a plurality of other endpoints through the enterprise network. The endpoint may have a data recorder that stores an event stream of event data for computing objects, a filter for creating a filtered event stream with a subset of event data from the event stream, and a query interface for receiving queries to the data recorder from a remote resource, the endpoint further including a local security agent configured to detect malware on the endpoint based on event data stored by the data recorder, and further configured to communicate the filtered event stream over the enterprise network. The threat management facility may be configured to receive the filtered event stream from the endpoint, detect malware on the endpoint based on the filtered event stream, and remediate the endpoint when malware is detected, the threat management facility further configured to modify security functions within the enterprise network based on a security state of the endpoint.

The threat management facility may be configured to adjust reporting of event data through the filter in response to a change in the filtered event stream received from the endpoint. The threat management facility may be configured to adjust reporting of event data through the filter when the filtered event stream indicates a compromised security state of the endpoint. The threat management facility may be configured to adjust reporting of event data from one or more other endpoints in response to a change in the filtered event stream received from the endpoint. The threat management facility may be configured to adjust reporting of event data through the filter when the filtered event stream indicates a compromised security state of the endpoint. The threat management facility may be configured to request additional data from the data recorder when the filtered event stream indicates a compromised security state of the endpoint. The threat management facility may be configured to request additional data from the data recorder when a security agent of the endpoint reports a security compromise independently from the filtered event stream. The threat management facility may be configured to adjust handling of network traffic at a gateway to the enterprise network in response to a predetermined change in the filtered event stream. The threat management facility may include a machine learning model for identifying potentially malicious activity on the endpoint based on the filtered event stream. The threat management facility may be configured to detect potentially malicious activity based on a plurality of filtered event streams from a plurality of endpoints. The threat management facility may be configured to detect malware on the endpoint based on the filtered event stream and additional context for the endpoint.

The data recorder may record one or more events from a kernel driver. The data recorder may record at least one change to a registry of system settings for the endpoint. The endpoints may include a server, a firewall for the enterprise network, a gateway for the enterprise network, or any combination of these. The endpoint may be coupled to the enterprise network through a virtual private network or a wireless network. The endpoint may be configured to periodically transmit a snapshot of aggregated, unfiltered data from the data recorder to the threat management facility for remote storage. The data recorder may be configured to delete records in the data recorder corresponding to the snapshot in order to free memory on the endpoint for additional recording.

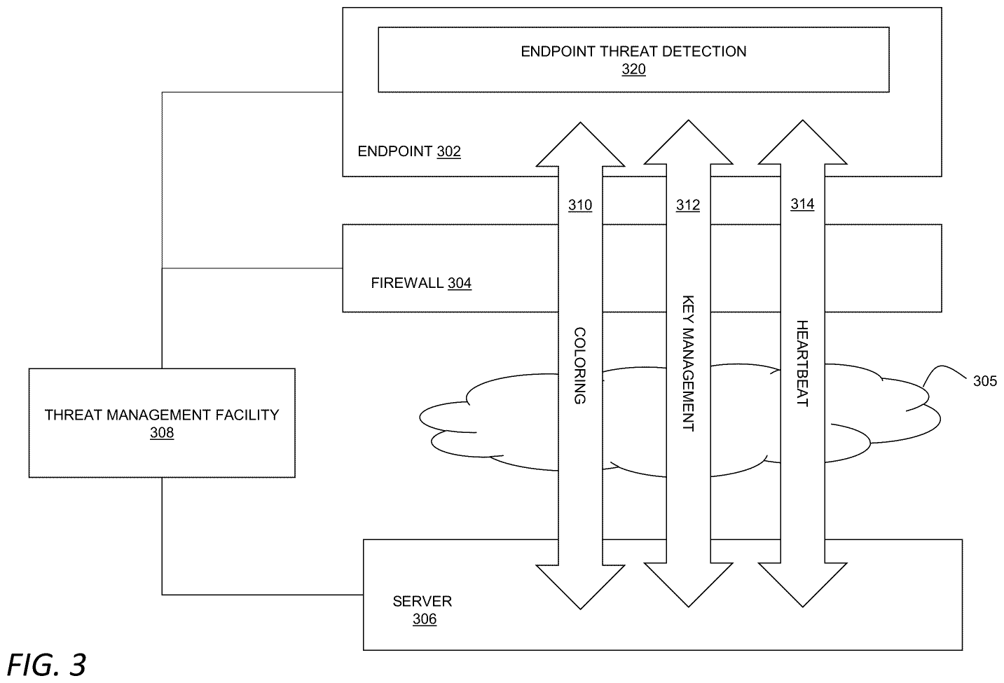

FIG. 3 illustrates a threat management system. In general, the system may include an endpoint 302, a firewall 304, a server 306 and a threat management facility 308 coupled to one another directly or indirectly through a data network 305, all as generally described above. Each of the entities depicted in FIG. 3 may, for example, be implemented on one or more computing devices such as the computing device described herein. A number of systems may be distributed across these various components to support threat detection, such as a coloring system 310, a key management system 312 and a heartbeat system 314, each of which may include software components executing on any of the foregoing system components, and each of which may communicate with the threat management facility 308 and an endpoint threat detection agent 320 executing on the endpoint 302 to support improved threat detection and remediation.

The coloring system 310 may be used to label or color software objects for improved tracking and detection of potentially harmful activity. The coloring system 310 may, for example, label files, executables, processes, network communications, data sources and so forth with any suitable information. A variety of techniques may be used to select static and/or dynamic labels for any of these various software objects, and to manage the mechanics of applying and propagating coloring information as appropriate. For example, a process may inherit a color from an application that launches the process. Similarly, a file may inherit a color from a process when it is created or opened by a process, and/or a process may inherit a color from a file that the process has opened. More generally, any type of labeling, as well as rules for propagating, inheriting, changing, or otherwise manipulating such labels, may be used by the coloring system 310 as contemplated herein.

The key management system 312 may support management of keys for the endpoint 302 in order to selectively permit or prevent access to content on the endpoint 302 on a file-specific basis, a process-specific basis, an application-specific basis, a user-specific basis, or any other suitable basis in order to prevent data leakage, and in order to support more fine-grained and immediate control over access to content on the endpoint 302 when a security compromise is detected. Thus, for example, if a particular process executing on the endpoint is compromised, or potentially compromised or otherwise under suspicion, keys to that process may be revoked in order to prevent, e.g., data leakage or other malicious activity.

The heartbeat system 314 may be used to provide periodic or aperiodic information from the endpoint 302 or other system components about system health, security, status, and so forth. A heartbeat may be encrypted or plaintext, or some combination of these, and may be communicated unidirectionally (e.g., from the endpoint 302 to the threat management facility 308) or bidirectionally (e.g., between the endpoint 302 and the server 306, or any other pair of system components) on any useful schedule.

In general, these various monitoring and management systems may cooperate to provide improved threat detection and response. For example, the coloring system 310 may be used to evaluate when a particular process is potentially opening inappropriate files based on an inconsistency or mismatch in colors, and a potential threat may be confirmed based on an interrupted heartbeat from the heartbeat system 314. The key management system 312 may then be deployed to revoke keys to the process so that no further files can be opened, deleted, or otherwise modified. More generally, the cooperation of these systems enables a wide variety of reactive measures that can improve detection and remediation of potential threats to an endpoint.

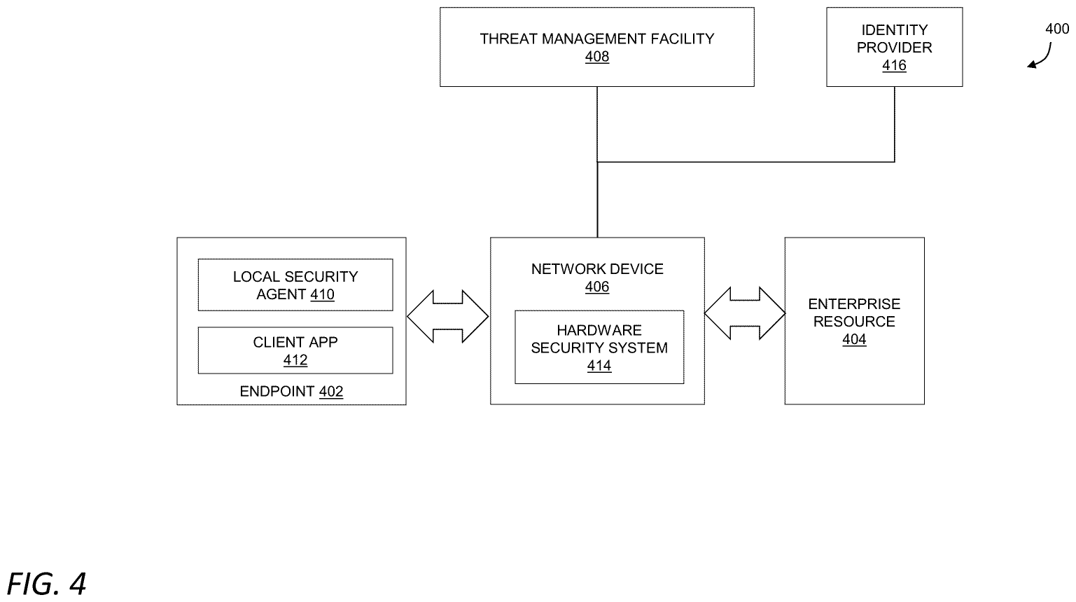

FIG. 4 shows an enterprise network. In the enterprise network 400, an endpoint 402 may access an enterprise resource 404 through a network device 406, with security for the enterprise network managed by a threat management facility 408. In general, the enterprise network 400, the endpoint 402, the enterprise resource 404, the network device 406, and the threat management facility 408 may be any of those described herein.

The endpoint 402 may include any of the endpoints, endpoint devices, compute instances, or other physical or virtual computing devices described herein. In one aspect, a user of the endpoint 402 may request or seek to use the enterprise resource 404 protected by the network device 406. The endpoint 402 may execute a local security agent 410, also as described herein, that locally manages security of the endpoint 402 in cooperation with the threat management facility 408. The endpoint 402 may also execute a local application such as a web browser or other application that accesses (or requests access to) the enterprise resource 404 through the network device 406.

The enterprise resource 404 may generally include any application, database, data store, file server, web server, mail server, or other resource supported by an enterprise, including an application or the like locally hosted on customer premises, one or more remote resources, or any combination of these. In one aspect, the enterprise resource may include a protected resource such as an application secured by password access, and/or a zero trust network access resource accessible through a zero trust network access gateway for the enterprise network.

The network device 406 may include any network device such as a firewall, switch, wireless access point, gateway, and so forth. In general, services operating on the network device 406 may support network connectivity among other devices (including access to the enterprise resource 404), and may support enterprise threat management through a connection to the threat management facility 408 and the local security agent 410 executing on the endpoint 402. The network device 406 may advantageously incorporate a hardware security system 414 such as a dedicated chip or circuit that stores data for authenticating the network device 406 to other devices, or otherwise securing operation of the network device 406 or verifiably asserting an identity of the network device 406. For example, Trusted Platform Module (TPM) is an international standard for a dedicated hardware cryptoprocessor that specifies an architecture, security algorithms, cryptographic primitives, root keys, authorization standards, and so forth that can be used for authentication. A TPM cryptoprocessor securely stores device-specific key material that is bound to a device at manufacture. The cryptoprocessor may also supports various cryptographic functions (e.g., encryption, decryption, hashing, key generation, random number generation, etc.) for remote attestation, so that the cryptoprocessor can reliably authenticate the device to other entities on demand. In the context of a secure enterprise network, the hardware security system 414 permits the network device 406 to authenticate to the threat management facility 408 automatically or semi-automatically when the network device 406 is physically connected to a customer's enterprise network. While the Trusted Platform Module standard provides a useful and highly secure, hardware-based security system, any other standardized, proprietary, and/or commercial hardware-based security system may also or instead be used as the hardware security system 414, provided the system offers suitable security, and, where applicable, provided the system supports remote authentication of the network device 406, e.g., from the threat management facility 408. For example, Platform Trust Technology from Intel™ and PSP fTPM from AMD™ provide similar functions and security to the TPM standard, and may be used to provide a hardware security system 414 as contemplated herein.

In one aspect, the network device 406 may include a zero trust network access (ZTNA) gateway that provides secure connectivity for user devices, such as the endpoint 402, to a protected resource such as the enterprise resource 404. The zero trust network access gateway, may, for example, support client access via a WebSocket service, and/or agentless access using a reverse proxy. The zero trust network access gateway may facilitate establishing and maintaining a connection with an endpoint-deployed local security agent 410 that is adapted for operation in a ZTNA environment. In general, the zero trust network access gateway may require authentication of endpoints 402 on a resource-by-resource basis. To this end, the enterprise network 400 may include, or may be coupled to, an identity provider 416 that supports, e.g., secure, credential-based authentication of entities within the zero trust network system of the enterprise network 400.

The threat management facility 408 may include any of the threat management facilities or other security resources described herein. The threat management facility 408 may generally support security of the enterprise network 400, including a range of administrative services such as configuring gateways, managing protected resources, configuring the identity provider 416, monitoring ZTNA appliances, creating notifications, generating reports, managing users, and the like. In one aspect, the threat management facility 408 may support security by detecting new network hardware such as the network device 406 when it is added to the enterprise network 400, and by authenticating the new network hardware, such as the network device 406, before permitting network traffic through the network device 406.

In one aspect, the network device 406 may itself be an endpoint 402 that is managed by the threat management facility 408. It should also be noted that an endpoint 402 other than a network device, such as a client device or other end user device, may also include a hardware security system 414 that can be used to authenticate an end user or an end user device to the threat management facility 408 (e.g., for delivery of security services or for entry into a managed enterprise network), or to authenticate to a ZTNA gateway or the enterprise resource 404 (e.g., for zero trust network access to the enterprise resource 404 by a user of the device). Thus, notwithstanding specific embodiments described herein, the hardware security system 414 may generally be used to authenticate new hardware securely and reliably when it is added to the enterprise network 400, or to authenticate a device or device user when requesting access to network resources, or any combination of these.

In one aspect, the local security agent 410 may provide a secure heartbeat, such as any of the secure heartbeats described herein. In the context of network access, the secure heartbeat may be used to assert an identity of a device, a device user, or a security posture of the endpoint 402 in order to facilitate access to the enterprise resource 404, security services of the threat management facility 408, or other network resources associated with the enterprise network 400.

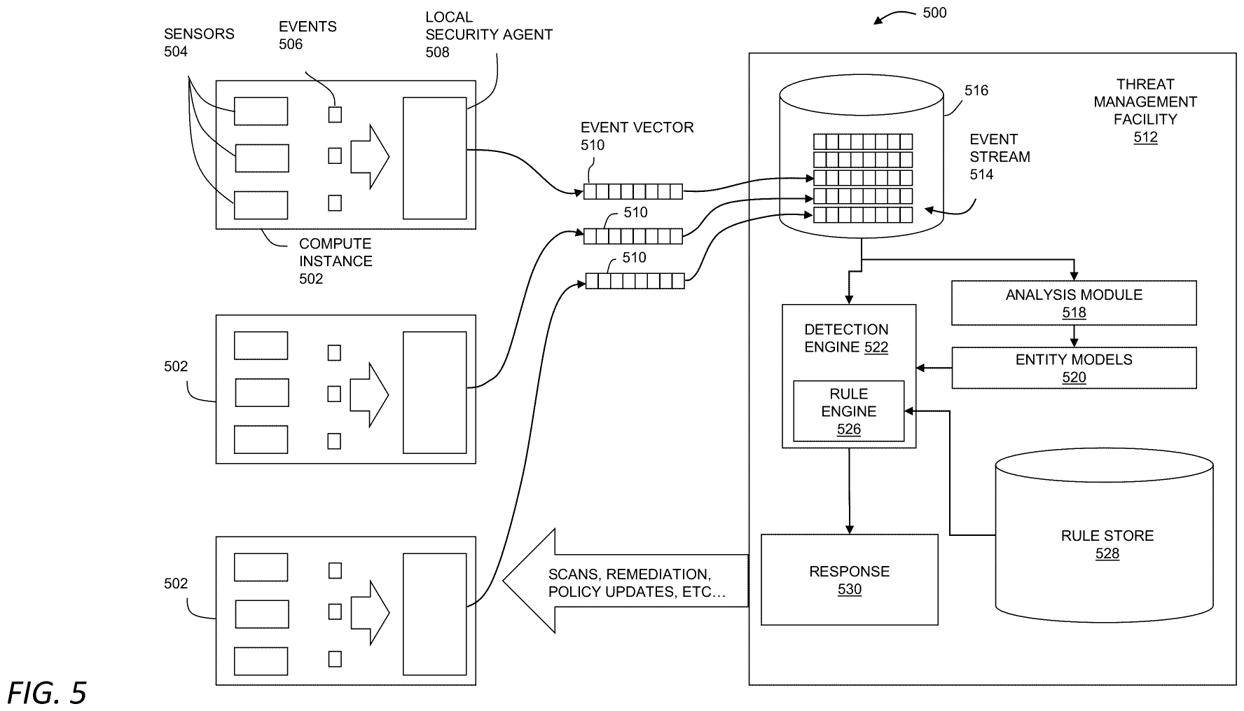

FIG. 5 shows a system for event monitoring and response. In general, the system may include a number of compute instances 502 that use local security agents 508 to gather events 506 from sensors 504 into event vectors 510, and then report these event vectors 510 to a threat management facility 512. The threat management facility 512 may store the event vectors 510 from a number of compute instances 502 as an event stream 514 in a data repository 516 such as a memory or other data store of the threat management facility 512. The event stream 514 may be analyzed with an analysis module 518, which may in turn create entity models 520 useful for detecting, e.g., unexpected variations in behavior of compute instances 502. A detection engine 522 may be applied to the event stream 514 in order to detect unusual or malicious activity, e.g., based on the entity models 520 or any other techniques. Where appropriate, the threat management facility 512 may deploy responses to the compute instances 502 using a response facility 530. In general, terms such as “security event” or “event,” as used herein, are intended to refer to individual events 506 and/or event vectors 510, unless a more specific meaning is otherwise provided or clear from the context.

The compute instances 502 may be any of the compute instances described herein, including without limitation any physical device such as a laptop, desktop, gateway, router, firewall, smartphone, tablet, or the like, as well as a virtualized instance of any of the foregoing or any other computer, user device, container, or the like. The sensors 504 and events 506 may also generally be any of the sensors and events described herein. The local security agent 508 may be any of the security agents described herein, or any other software component or the like executing on or in association with one of the compute instances 502 to locally manage security of the compute instance and/or coordinate security services with the threat management facility 512 and other remote resources.

The local security agent 508 may collect events 506 from sensors 504 on the compute instance 502, and form the collected events 506 into event vectors 510 for communication to the threat management facility 512. The sensors 504 and/or local security agent 508 may usefully process events 506 in a number of ways in order to facilitate communication, computational efficiency, or downstream processing. For example, events 506 may be tokenized. That is, a process that causes or creates an event 506 may be assigned a number or other identifier, which may be used locally by a compute instance or globally within the enterprise to identify a particular, known process. An event 506 may also encode (tokenized or otherwise) a relationship among different processes. For example, for a particular process that caused an event 506, a parent-child relationship or other dependency with other processes may be encoded by providing process identifiers or the like within the event 506, along with information characterizing the relationship among the processes. A Uniform Resource Locator or other information for identifying resources or network locations may also be tokenized or otherwise processed to support efficiency, consistency, and the like. For example, a URL may be encoded in an event 506 as a hash of a URL, or as a portion of a URL, or some combination of these (e.g., a literal encoding of the top level domain, and a hash of some or all of the remaining path information). Other events 506 such as registry changes, system calls, remote procedure calls and the like may be literally encoded into an event 506 where they are relatively compact, or identified using any suitable tokenization, compression, or the like.

Other techniques may also or instead be used. For example, user-specific or machine-specific information may be altered where appropriate to anonymize the event vectors 510 and mitigate exposure of sensitive information during network communications. An event vector 510, or individual events 506 therein, may also or instead be encrypted in order to secure the contents against malicious interception. In another aspect, the events 506 or event vectors 510 may be compressed to conserve network resources. The event vectors 510 may also or instead be prioritized, e.g., in order to increase sensitivity and decrease response times for event vectors 510 associated with a high likelihood of malicious activity. In this latter aspect, the local security agent 508 may locally analyze events 506 and/or event vectors 510 in order to permit suitable prioritization, as well as to support local detection and response to malicious, or potentially malicious activity.

It will also be appreciated that events 506 and/or event vectors 510 may usefully be labelled in a variety of ways. While labeling with process identifiers is described above, this may also or instead include an identification of an entity associated with the event 506 or event vector 510. In this context, the entity may be any physical, logical, or conceptual entity useful for monitoring activity of compute instances 502 as described herein. For example, the entity may include a user, a physical device, a virtualized machine, an operating system, an application, a process, a hardware subsystem (e.g., a network interface card, USB drive, camera, etc.), a network resource, a domain controller, a remote software service, and so forth. It should also be understood that the various entity types may be concurrently associated with a particular event 506, sensor 504, or event vector 510, or particular events 506 may be associated with multiple entities or event vectors 510. Thus, for example, storing a file may be an event 506 associated with a particular user, a particular machine, a particular operating system, a particular physical storage device, and so forth. In one aspect, each event 506 or event vector 510 may be structured as a data blob, data object, or the like labelled with metadata provided a source identifier or other context information that can be used to select applicable rules as described herein.

In one aspect, the event vectors 510 may be organized around entities, which may be used to provide context or information for rule selection. Thus, for example, a request for access to a network resource may be an event 506. When such a request is initiated by a user, an event vector 510 for that user may be created and reported along with other temporally adjacent or otherwise related events 506 associated with that user. Where the network request involves an interaction with, e.g., an authentication and identity management system, this may be represented as another entity, or as an event 506 (or group of events 506) in the event vector 510 for the user. At the same time, a second event vector 510 for the compute instance 502 may also be created and reported along with other temporally adjacent or otherwise related events 506 associated with that compute instance 502. Alternatively, the event vectors 510 may be organized around chronology. That is, groups of events 506 within a window of time may be reported as an event vector 510. The event vectors 510 may also or instead be organized around other aspects of the system 500, such as particular sensors 504 or groups of sensors 504, causal relationships among events 506, particular triggers, types of activity (e.g., network communications, operating system, processes, etc.) and so forth. In general, the source of each event 506, such as a particular sensor 504, or some entity, computing object, computing platform, hardware configuration, operating system, or the like associated with the sensor 504, may be encoded with the event 506 to permit explicit identification by the threat management facility 512 or other downstream processing resources. Although depicted in FIG. 5 as having similar size, it will also be understood that the event vectors 510 may be any size, and may usefully encode any number of different events 506.

The event vectors 510 may be received by the threat management facility 512 and stored as an event stream 514 in a data repository 516, which may be any data store, memory, file or the like suitable for storing the event vectors 510. The event vectors 510 may be time stamped or otherwise labeled by the threat management facility 512 to record chronology. In general, the event stream 514 may be used for analysis and detection as further described herein.

In general, an analysis module 518 may analyze the event stream 514 to identify patterns of events 506 within the event stream 514 useful for identifying unusual or suspicious behavior. In one aspect, this may include creating entity models 520 that characterize behavior of entities, such as any of the entities described herein. Each entity model 520 may, for example, include a multi-dimensional description of events 506 for an entity based on events 506 occurring over time for that entity. This may be, e.g., a statistical model based on a history of events 506 for the entity over time, e.g., using a window or rolling average of events 506.

The entity models 520 may, for example, be vector representations or the like of different events 506 expected for or associated with an entity, and may also include information about the frequency, magnitude, or pattern of occurrence for each such event 506. In one aspect, the entity model 520 may be based on an entity type (e.g., a particular type of laptop, or a particular application), which may have a related event schema that defines the types of events 506 that are associated with that entity type. This may usefully provide a structural model for organizing events 506 and characterizing an entity before any event vectors 510 are collected, and/or for informing what events 506 to monitor for a particular entity, or what events 506 to associate with a particular entity.

As an event stream 514 is collected, a statistical model or the like may be developed for each event 506 represented within the entity model so that a baseline of expected activity can be created. In one aspect, an existing model may be used, e.g., when the entity or entity type is already known and well characterized. The entity model may also or instead be created by observing activity by the entity (as recorded in the event stream 514) over time. This may include, for example, monitoring the entity for an hour, for a day, for a week, or over any other time interval suitable for creating a model with a sufficient likelihood of representing ordinary behavior to be useful as a baseline as contemplated herein. In one practical example, certain software applications have been demonstrated to yield a useful baseline within about two weeks. It will also be understood that, once an entity model is created, the entity model may usefully be updated, which may occur at any suitable intervals according to, e.g., the length of time to obtain a stable baseline, the amount of activity by the entity, the importance of the entity (e.g., to security, operation of a compute instance 502, and so forth), or any other factors.

These techniques may be used to create an entity model 520 for any of the entities described herein, including without limitation physical hardware items, virtualized items, software items, data and date stores, programming interfaces, communications interfaces, remote resources, and so forth, or any of the other entities, computing objects, assets or the like described herein. In one aspect, the entities may be arranged around a conceptual stack for an endpoint in an enterprise network, such as by providing entities for a domain controller, a compute instance, a user, an operating system, a library, an application, a process, and data. This may also or instead include any of a number of physical devices such as a laptop, a desktop, a gateway, a router, a firewall, a smartphone, a tablet, a personal computer, a notebook, a server, a mobile device, an IoT device. The entity may also or instead include hardware subsystems such as a peripheral, a keyboard, a mouse, a display, a network interface card, a USB drive, a camera, a disk drive or other physical storage device, and so forth. The entity may also or instead include a virtualized instance of any of these physical devices or systems, or any other virtualized compute instance or other computing resource such as a virtual machine, a hypervisor, or the like. In another aspect, this may include computing objects or resources such as a container, an operating system, a library, an application, a process, a file or other data, or the like. An entity may also or instead include remote resources, such as a cloud computing resource, cloud data resource, remote software service, or any other network resource or the like. An entity may also include other entities such as a user or related identity, or more specific system resources such as a kernel driver, system registry, process cache, and so forth. More generally, any physical, virtual, logical, or other computing resource, asset, or the like that can usefully be instrumented and/or monitored to provide events and/or used to select applicable rules may be an entity as that term is used in this description.

As noted above, the entities of interest here may exist non-exclusively at various levels of hardware and software abstraction, and the entity models may similarly be of varying and overlapping scope. By way of a non-limiting example, an entity model for a laptop may include applications running on the laptop. In one aspect, the entity model may incorporate all network activity by the laptop, while in another aspect, network activity may be associated with the entity models for specific applications. Or the network activity may be associated with both entities, e.g., such that a single event is incorporated into multiple event vectors associated with multiple entities. In general, these design choices may affect the granularity of detections, the amount of processing and communications overhead, and so forth, and any such variations consistent with deployment within an enterprise network as contemplated herein are intended to fall within the scope of this disclosure.

The detection engine 522 may compare new events 506 generated by an entity, as recorded in the event stream 514, to the entity model 520 that characterizes a baseline of expected activity. By representing the entity model 520 and the event vectors 510 in a common, or related, vector space, deviations from expected behavior can usefully be identified based on the vector distance between one or more event vectors 510 and the entity model 520. This comparison may usefully employ a variety of vector or similarity measures known in the art. For example, the comparison may use one or more vector distances such as a Euclidean distance, a Mahalanobis distance, a Minkowski distance, or any other suitable measurement of difference within the corresponding vector space. In another aspect, a k-nearest neighbor classifier may be used to calculate a distance between a point of interest and a training data set, or more generally to determine whether an event vector 510 should be classified as within the baseline activity characterized by the entity model.

In another aspect, the detection engine 522 may include a rule processing engine 526, also referred to herein as a rule processor, event processor, rule engine, and the like. The rule processing engine 526 may be configured by computer executable code to select applicable rules from a rule store 528 based on the source of events (or other event context), and to apply the selected rules to perform detections. In general, the rule store 528 may store rule objects that include one or more detection rules for detecting malicious activities, as well as one or more load rules providing selection criteria for determining, based on a platform configuration or other context or information for a source of a security event, whether to load the one or more detection rules of the rule object for use by the rule processing engine 526 to evaluate the security event for potential malware. The rule store 528 may, for example, be implemented as an S3 bucket, or any other cloud computing data store or other data store, database, or other memory or the like, suitable for use with rule objects as described herein.

In one aspect, the rule store 528 may perform functions related to rule selection. For example, the rule store 528 may usefully be configured to select a group of rule objects for the rule processing engine 526 by comparing load rules contained in each rule object to the corresponding information in the event objects. With this technique, processing can advantageously be allocated between the rule store 528 (which may be optimized for data retrieval) and the rule processing engine 526 (which may be optimized for executing program logic found in detection rules) to facilitate distributed processing in a manner that optimizes use of computing resources.

In general, the detection engine 522 may also or instead employ other detection techniques based on the event stream 514, e.g., to support real time detection of suspicious or malicious behavior. For example, certain events 506 may be independently and directly indicative of malicious activity, such as initiating communications with a known command and control center for an advanced persistent threat. Other events 506 may be potentially indicative of malicious activity, such as initiating disk-wide encryption or transmitting sensitive information from an endpoint. While tools exist for detecting these types of malicious activity, relevant events 506 may be present in the event stream 514, and the response facility 530 may usefully trigger additional analysis, investigation, or other responses based on the event stream 514 instead of or in addition to monitoring for deviations from entity baselines. In another aspect, concurrent deviations by different entities, or a pattern of deviations for a single entity or among entities, may also be usefully monitored. For example, a deviation in the behavior of a trusted application across multiple compute instances 502, either concurrently or in succession, may indicate a rollout of a software update rather than malicious behavior. Conversely, if a number of compute instances 502 concurrently begin contacting an unknown network address, this may be an indication of malware propagating among devices in an enterprise network. More generally, deviations among different entities, or among multiple instances of a particular entity, may provide useful information about actual or potential causes of the change, and may inform subsequent manual or automated investigations.

Where malicious or potentially malicious activity is detected, any number of responses may be initiated by the response facility 530 of the threat management facility 512. In one aspect, this may include deployment of known remediations for malicious activity such as quarantine, termination of network communications, termination of processes or applications, an increase in local monitoring activity on affected compute instances 502, messages to a network administrator, filtering of network activity, antivirus scans, deployment of security patches or fixes, and so forth. This may also include policy updates. For example, security policies for compute instances 502, users, applications or the like may be updated to security settings that impose stricter controls or limits on activity including, e.g., limits on network activity (bandwidth, data quotas, permitted network addresses, etc.), limits on system changes (e.g., registry entries, certain system calls, etc.), limits on file activity (e.g., changes to file permissions), increased levels of local activity monitoring, and so forth.

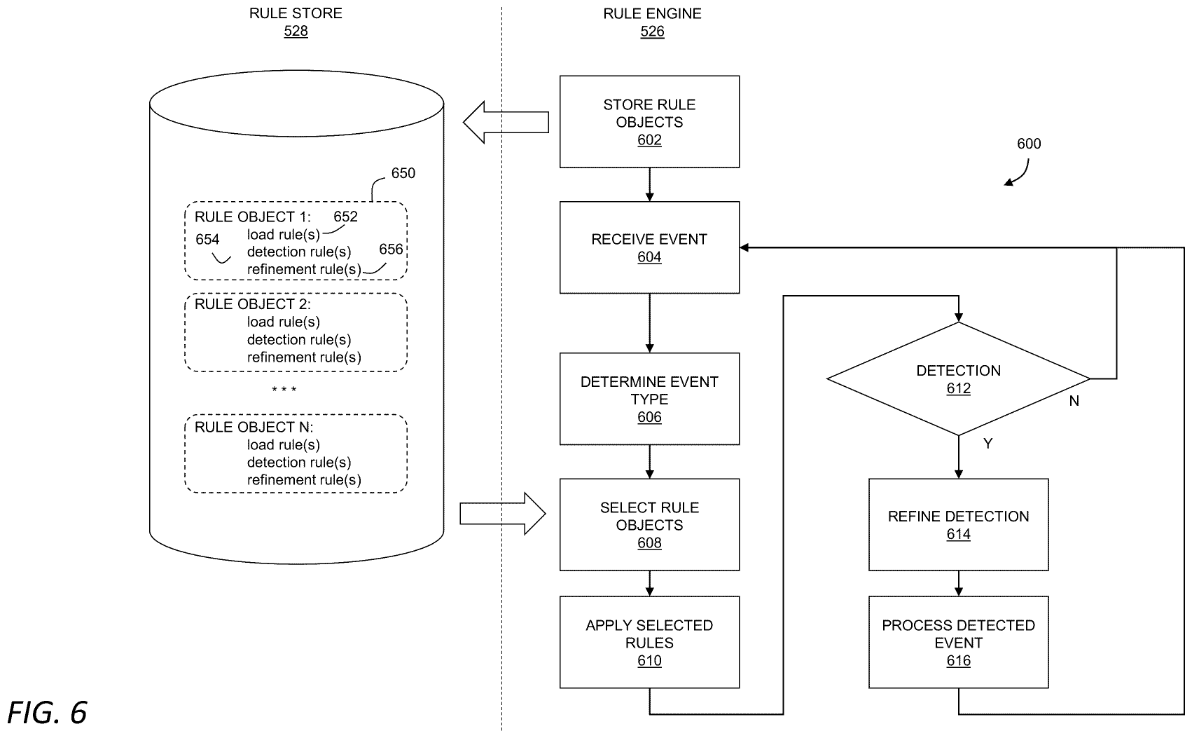

FIG. 6 shows a method for processing rules. This may include any of the rule objects with self-defined context as described herein. The method 600 may be performed, e.g., by a rule processing engine associated with a threat management facility, such as the rule processing engine 526 illustrated in FIG. 5, or any other software and/or hardware suitably configured to process rule objects as described herein. The method 600 may be performed in cooperation with a rule store such as the rule store 528 illustrated in FIG. 5, or any other data store, data repository, cloud-based data service, memory or the like suitable for storing rule objects as described herein.

In general, threat management systems are faced with increasing volumes of security data, as well as an increasing diversity of security threats, all of which continue to evolve and expand. A rule processing engine as described herein may advantageously use rules that self-define their relevant context, which permits the rule processing engine to proactively limit the detection rules on an event-by-event basis. At the same time, rules with self-defined context can be more compact because the corresponding detection rules can be more concisely expressed for targeted events. When a rule processing engine is invoked to perform a detection based on an event, the rule processing engine can select appropriate rule objects based on the corresponding load rules, before engaging the processing resources required to programmatically execute detection rules and perform a threat detection.

It will be noted that, while the following description emphasizes a threat management context and the corresponding use of security events, the principles described herein may be used in any context where rules can usefully be pre-selected to process events in an event stream. For example, event stream architectures are used in financial trading, predictive analytics, inventory management, user activity monitoring, fraud detection, payment processing, and so forth. More generally, in any context where processing can usefully be performed on a continuous flow of data, the principles of the system described herein can advantageously be employed. As such, the term security event, as used herein, should be understood to more generally contemplate any event that might be communicated in an event stream, unless a more specific meaning is explicitly provided or otherwise clear from the context.

As shown in step 602, the method 600 may include storing a plurality of rule objects for processing events such as security events in an event stream of an enterprise network. Each of the rules may include one or more detection rules for detecting malicious activities, as well as one or more selection criteria, expressed as load rules in each rule object, for determining whether to load the one or more detection rules of the rule object based on a platform configuration or other attributes of a source of a security event.

In one aspect, each rule object may include one or more load rules that are used to determine whether the rule object is applicable to an event. In one aspect, the events may be security events in an event stream for a threat management facility. The events may, for example, include a JavaScript Object Notation (JSON) object—a text-based format for representing structured data—or any other alert, event, message, or other data structure or the like used to communicate data such as threat telemetry from endpoints in an enterprise network. In general, these communications are referred to herein as “events” or “security events,” although other descriptions (such as “document”) may be used as appropriate for more specific event data types, message formats, and so forth.

The load rules may specify selection criteria for identifying when a rule object applies to a particular event. In one aspect, this may depend on the source of an event. For a security event this may depend on platform or configuration information for a compute instance associated with an enterprise network, or any other source of security telemetry or the like. For example, one useful filtering criterion is the platform of the source, which may be an operating system type, a hardware type, and so forth. For example, a load rule may specify a platform such as an operating system to which a rule object applies, e.g., “Windows,” “macOS,” “Linux,” “IOS,” “Android,” and so forth. This may also or instead include sub-categories for, e.g., operating system versions or the like. Other load rules may also or instead be used to filter rule objects based on other platform information such as security software, geography, user types, software configuration (e.g., installed applications, installed security software, and so forth), and/or any other criteria useful for tailoring detection rules to a particular detection context.

By way of non-limiting examples, the type of the event may include a platform configuration for a source of the event, such as an operating system configuration or a software configuration for the source. In another aspect, the type of the event may include a source of the event, such as a telemetry source within an enterprise network. For example, the source of the event may include a compute instance associated with an enterprise network, which may be further specified as, e.g., a type of the compute instance, an identifier for the compute instance, a software configuration for the compute instance, an operating system for the compute instance, and so forth. In another aspect, the source of the event may include a sensor on a compute instance, an application on a compute instance, a process executing on a compute instance, a network interface on a compute instance, a medium access control identifier on a compute instance, or any other logical or physical source associated with the event. In another aspect, the source of the event may include a firewall associated with an enterprise network, a gateway associated with the enterprise network, or a network device associated with the enterprise network.

Load rules may be hierarchical and/or compound in nature. In one aspect, compound load criteria may include a plurality of conditions (e.g., operating system, device type, user, process, and the like). Each rule object may define how the conditions are to be evaluated for selecting the rule object. As an example, a rule object may identify five selection criteria. One rule object may require that all five criteria match to the event object, while another rule object may require that any one of the five application criteria matches to the event object, and another rule object may require that a majority (e.g., three out of five) of criteria are satisfied. In another aspect, hierarchical load criteria may be used, e.g., to support faster sorting of applicable rule objects. Thus for example, the load criteria may include WINDOWS:10, WINDOWS:11, and so forth to specify different versions of an operating system. When a Windows operating system is identified, an initial candidate list of relevant rule objects may be chosen before refining based on the version of the operating system. While not necessary for efficient functioning of the systems and methods described herein, these types of more complex load rules may be used in certain circumstances to improve processing speed, e.g., where it is more computationally efficient to filter by load rules than to apply detection rules.

Each rule object may include one or more detection rules that can be applied, e.g., to security events to detect malicious, suspicious, or otherwise noteworthy events within an enterprise network. The detection rules may include any suitable rules for detecting malware or otherwise processing events in an enterprise network environment such as any of those described herein. In one aspect, this may include legacy rules, such as rules from a previous threat detection platform or environment. In this case, a rule engine may invoke a converter for handling detection rules that are expressed using a syntax, format, and the like from a different (legacy) environment, and applying these rules in the native environment for the rule engine. The detection rules may also or instead include rules authored for a particular customer or security context, which may contain any suitable criteria, logic, rules, conditions, thresholds, or the like useful for detecting activity of interest based on security events. These rules may, for example, be expressed in the language of an interpreter or the like that is used as the rule engine. For example, the rules (and more generally, the rule object) may be expressed in Python, or in Starlark, which is a lightweight dialect of Python commonly used in security environments.

In one aspect, the detection rules may be rules that resolve in a binary fashion to a true/false or I/O in order to indicate whether or not a detection is made, however, other outcomes (e.g., “unknown”) or outputs (e.g., a score) may also or instead be generated by detection rules as contemplated herein. In another aspect, the detection rules may include, or may be accompanied by, one or more standard rules or built-in rules that are available for use in creating other detection rules. This may, for example, facilitate re-use of commonly used functions, data sources, libraries, threat detection strategies, and so forth, and may be implemented as resources that are available for explicit use within individual rule objects, or that are available as a separate class or category of rule objects that are available to and/or applied to all types of event objects.

Each rule object may also or instead include one or more refinement rules. These rules generally provide instructions for additional processing of an event after a detection is made based on one of the detection rules. This may, for example, include information to control presentation or display of results, select communications channels or addresses for reporting alerts, incorporate detection metadata or supplemental data into a result, provide scoring information (e.g., for threat severity), and so forth. For example, refinement rules may specify a detection identifier for the source or the event to assist in downstream processing, or provide a description of the detected event. Refinement rules may also provide details such as a unique event identifier for the event (or events) causing the detection. Where the event is a security event, and the detection is a detection of malicious activity, the refinement rule(s) may specify one or more of a severity score for the detection, a detection type that characterizes the detected threat, a MITRE attack classification for the detection, a remediation category for the detection, and so forth.

The data structure for a rule object 650—load rules 652, detection rules 654, and refinement rules 656—permits detection logic to be stored as rule objects 650 that self-define a context in which they apply, as well as what to do when a detection is made. Rule objects 650 may be stored, e.g., in a data store such as any of the rule stores described herein. By storing rule objects 650 as JSON objects or other human-readable data structures, authoring tools can support direct access to the underlying rules in a text-based editor or other console or interface so that the rules can be inspected and edited by administrators, technicians, and other users that are responsible for managing security rules for an enterprise network.

As shown in step 604, the method 600 may include receiving an event. This may include receiving an event such as a security event at an event processing service, which may include any of the rule engines, detection engines, or threat management facilities described herein. In general, an event may be received as an event object, which may be formatted as a document, a message, a JSON object, or any other data object or the like suitable for communication in an event stream. The event may be a security event from a compute instance or endpoint in an enterprise network, or any other event from any other source.

As shown in step 606, the method 600 may include determining a type of an event, e.g., by determining a source of the event or other context associated with the event. For example, this may include determining a source of a security event by determining a platform configuration for a source of the security event object. The platform configuration (or other type or source information) may be extracted from metadata for the event object, inferred from an identifier for the source, or otherwise obtained or inferred using contextual information available from the event object itself, or other sources of data that can provide information for the source of the event object. For example, where an event object includes a network address or machine identifier for a source of the event object and a threat management facility maintains a database of additional information for managed devices, the threat management facility may use the identifying information in the event object to retrieve additional information from the database as needed to select appropriate rule objects.

As shown in step 608, the method 600 may include selecting rule objects based on the type of the event. For example, this may include selecting a group of one or more rule objects based on the platform configuration for the source of a security event object, or more generally, selecting one or more of the rule objects based on the type of the event object. This selection step generally includes matching type information for an event object with an applicable type contained in any corresponding load rules within the rule objects. This permits rules to self-define the types of events to which they apply, and advantageously permits a rule engine to focus processing resources on executing detection rules that are applicable to a particular event object. Avoiding the sequential execution of a complete rule set becomes increasingly beneficial as detection rules become more complex and computationally expensive, and as the number of types of objects increases. As another advantage, this eliminates any need to pre-organize rules, or otherwise curate or manage rules in the rule store prior to use of the rule engine.

In one aspect, the load step—where rule objects are selected for an event object based on the load rules—may be performed by the rule store 528 rather than the rule processing engine 526. This permits the rule processing engine 526 to offload processing work that is independent from applying detection rules so that the rule processing engine 526 can be used exclusively for executing detection rules, e.g., based on a group of rule objects that are provided by the rule store 528.

As shown in step 610, the method 600 may include applying the rules contained in the selected group of rule objects, such as by applying one or more detection rules from the group of rule objects to an event object such as a security event object. In general, this may include executing the detection rules in the selected group of rule objects in an environment such as any of the rule engines or other detection engines described herein. For example, the rule objects may be written in Starlark, and the rule engine may include a Starlark interpreter or the like. Starlark is a lightweight dialect of Python that provides numerous advantages in this context. Starlark is human-readable, relatively simple, and can be edited in a text editor or other simple command console or the like. Further, Starlark executes independent threads in parallel, which makes it highly scalable to facilitate use with large rule sets and/or high-volume event environments.

As illustrated in step 612, the method 600 may include taking an action that depends on whether the detection rule(s) result in a detection. If there is no detection, then the method 600 may return to step 604, where a new event may be received. If there is a detection, then the method 600 may proceed to step 614 for refinement. For example, in response to identifying one of the activities in the event object with the one or more detection rules from the group of rule objects, the method 600 may include initiating a response to the event. Or in the case of a network security system, the method 600 may include, in response to identifying one of the malicious activities in a security event object with the one or more detection rules from the group of rule objects, generating a notification of malicious activity. More generally, in the case of a detection, the method 600 may proceed to step 614 where further processing can be performed based on the detection.

As shown in step 614, the method 600 may include refining a detection. This may include modifying or augmenting information about the detection based on refinement rules contained in the corresponding rule object(s). For example, this may include adding metadata to a detection that describes the source, describes the nature of a threat or other detection, provides an estimate or description of a severity of a threat, identifies suitable recipients for an alert, or otherwise augments the detection with information that might be useful for downstream processing.

As shown in step 616, the method 600 may include processing a detected event, e.g., by initiating a response to the detected event. For example, where the activity includes a malicious activity detected in an enterprise network, initiating a response may include initiating a remediation for the malicious activity. This may include any suitable security remediation, such as transmitting a notification of malicious activity to a threat management facility for the enterprise network. In another aspect, initiating the remediation may include initiating a threat response to a malicious activity (e.g., the detected malicious activity) by a source of the event object. For example, the threat management facility may responsively quarantine, restart, update, or otherwise remediate a compute instance that generated the corresponding event object, e.g., from a local security agent executing on the compute instance. Thus, for example, initiating the remediation may include at least one of quarantining a source of the event object, updating security software for the source of the event object, performing a scan of the source of the event object, and requesting data from a data recorder for a local security agent executing on the source of the event object. More generally, the remediation may include any of the remediations described herein for addressing security threats, or any other actions or notifications suitable for handling a detected event or activity indicative of a security compromise as described herein.

In another aspect, processing the detected event may include performing any additional actions such as storing the detection in a suitable data repository, transmitting alerts, transmitting a notification to a threat management facility for an enterprise network, and so forth. After processing of the detection is completed, the method may return to step 604 where another event may be received. It will be understood that, while illustrated sequentially, any number of events may be received and processed in parallel, sequentially, or some combination of these, all without departing from the scope of this disclosure.

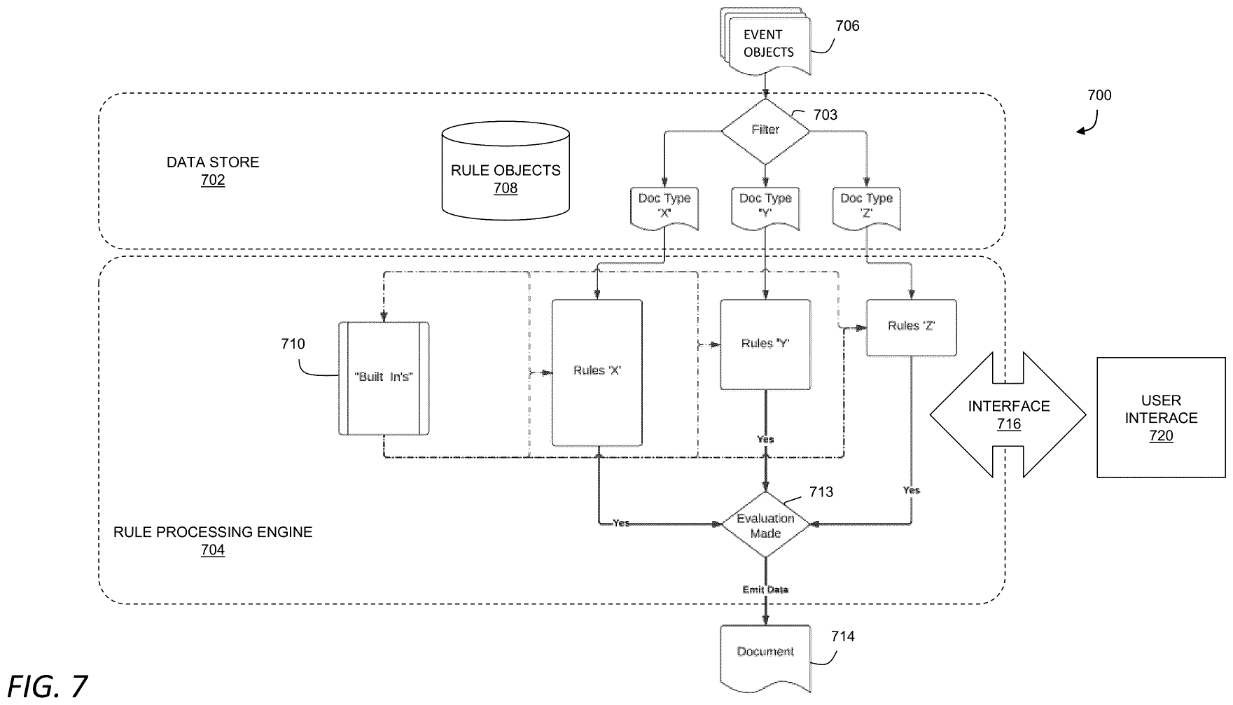

FIG. 7 illustrates a workflow for a rule processing system. In general, the system 700 may include a data store 702 and a rule processing engine 704 that cooperate as described herein to receive event objects 706, e.g., in an event stream, and produce a result 714 such as a document or other object when a relevant detection is made in one of the event objects 706 according to one or more detection rules in the rule objects stored in the rule object repository 708.

One or more event objects 706, such as any of the event objects described herein, may be received in an event stream at a threat management facility such as any of the threat management facilities described herein, or at any other suitable processing facility or the like. The event objects 706 may be sorted with a filter 703 of the data store 702 based on the load rules of one or more rule objects stored in a rule object repository 708 of the data store 702. As further described herein, the data store 702 may usefully perform this preliminary sorting function in order to offload some of the rule pre-processing from the rule processing engine 704, which may then be optimized to execute rules and other program logic and flow in order to apply the rules contained in the rule objects. As depicted in FIG. 7, the event objects 706 may generally be sorted into three types, labeled “X, “Y,” and “Z.” These may, for example, represent event objects 706 from Linux devices (X), event objects 706 from Windows devices (Y), and event objects 706 from macOS devices (Z), although it will be understood that any other number and type of event object sources may be used to sort event objects 706 as described herein, including hierarchical types, compound types, and so forth. While the example event objects 706 of FIG. 7 are labelled as “Doc Type,” it will be understood that each event object 706 may be any type of document, message, data object, or the like suitable for encapsulating event data for use in detections as described herein. In one aspect, the event objects 706 may be JSON data objects.

The rule processing engine 704 may apply a corresponding rule set, as selected from rule objects in the rule object repository 708 of the data store 702, for each object type. In the example of FIG. 7, this includes three types of rule sets labelled “X, “Y,” and “Z,” where each rule set is applicable to similarly typed event objects 706. As illustrated in FIG. 7, the rule processing engine 704 may also support one or more built-ins 710, which may include saved rules, processing steps, external resources, and the like that are made available by the rule processing engine 704 to all rules, and may be included as libraries, functions or the like in the processor or interpreter of the rule processing engine 704 so that they can be invoked in explicit function calls or the like within rules of the rule objects. This permits global re-use of common functions, useful data sources, libraries, and so forth that may not be present in a native language or environment of the rule processing engine 704, and or that are developed over time for a particular customer, industry, technical context, or the like.

In general, a result 714 or evaluation may be generated by the rule processing engine 704 by receiving a set of rule objects applicable to a type or source of an event object 706, performing an evaluation 713 by executing the detection rules contained in the set of rule objects, and when a detection is made based on the rules, refining a description of the detection according to one or more refinement rules contained in the corresponding rule object, all as further described herein. The results, including the detection and any data, description, or metadata created by the refinement rules, may be outputted as a result 714 such as a document or other data object or the like for further processing.

It will be understood that substantial additional processing and/or remediation may usefully be performed based on the result 714. For example, a threat detection facility associated with the rule processing engine 704 may apply meta-detection rules including time-based correlations based on, e.g., repeated occurrences of events over a time interval or within a time limit. In another aspect, the threat management facility may augment a detection with additional information from other sources, and analysis may traverse multiple events, endpoints, and the like. Furthermore, the threat management facility may be configured to measure, store, and maintain metrics on one or more detection rules. Metrics may be calculated for a range of detection rule performance-related factors (e.g., execution resource utilization/time), use factors (number of activations), results-factors (ratio of activations and detections) and the like.

In one aspect, the rule processing engine 704 and data store 702 may have a control interface 716 such as one or more HTTP interfaces through which calls (e.g., requests to process security events) and responses (e.g., results of detection processing, notifications and the like) may be communicated. Such an HTTP interface may be implemented as an Application Programming Interface (API) based on a representational state transfer (REST) architecture. A POST command may be used to submit one or more events for processing. Such an API may further be used to manage detection rules and application criteria in a rule object store. A rule object store may be managed through use of a GET command to receive a list of detection rules, such as a rules schema; a POST command to add one or more detection rules; a PUT command to update one or more detection rules; a DELETE command to detect one or more detection rules and the like. More generally, the control interface 716 may support human or machine interactions with the rule processing engine 704. The control interface 716 may connect the rule processing engine 704, e.g., to human users via a user interface 720 such as a console, web page, or the like, or to a computer program or other programmatic user such as a threat management facility, either of which may manage the rule processing engine 704, manage rule objects in the rule object repository 708 of the data store 702, specify the content or handling of the result 714, or otherwise usefully control operation of the rule processing engine 704.

In example embodiments, a rule processing engine 704 for detecting malicious activity may be configured with an application programming interface (API) that facilitates loosely coupled interactions with the security event processing service. In this way, a client or other facility may provide event objects 706 (e.g., as a stream of events) to the rule processing engine 704 for detecting malicious activity and receive the result 714 of processing the event object(s), optionally as a data stream of events that may include notifications, and the like. This API may be used for streaming of events to the rule processing engine for detecting malicious activity and optionally for streaming detections and/or notifications from the rule processing engine for detecting malicious activity. In one aspect, detection events such as the result 714 may be added to the event stream for the enterprise network or other system associated with the rule processing engine 704.

According to the foregoing, there is disclosed herein a system for processing security events in an event stream for an enterprise network, the system including a database and an event processor. The database may store a plurality of rule objects for processing the security events in the event stream. The plurality of rule objects may include one or more detection rules for detecting malicious activities and one or more selection criteria for determining, based on a type of a security event, whether to apply the one or more detection rules of the rule object to the security event. The rule processing engine may be configured by computer executable code stored in a non-transitory computer readable medium that, when executing on one or more processors, causes the rule processing engine to perform the steps of: receiving one of the security events as a security event object in the event stream, determining the type of the security event object, selecting a group of one or more of the plurality of rule objects stored in the database based on the type, applying each of the one or more detection rules for each rule object in the group of rule objects to the security event object, in response to at least one of the detection rules identifying one of the malicious activities, generating a notification of a detection of malicious activity, and transmitting the notification to a threat management facility for the enterprise network.

The rule processing engine may execute on the threat management facility for the enterprise network. The event stream may include security event objects from a plurality of compute instances in the enterprise network managed by the threat management facility. Each one of the plurality of rule objects may include one or more refinement rules that provide instructions for additional processing of one of the security events after the detection of malicious activity is made based on the at least one of the detection rules.

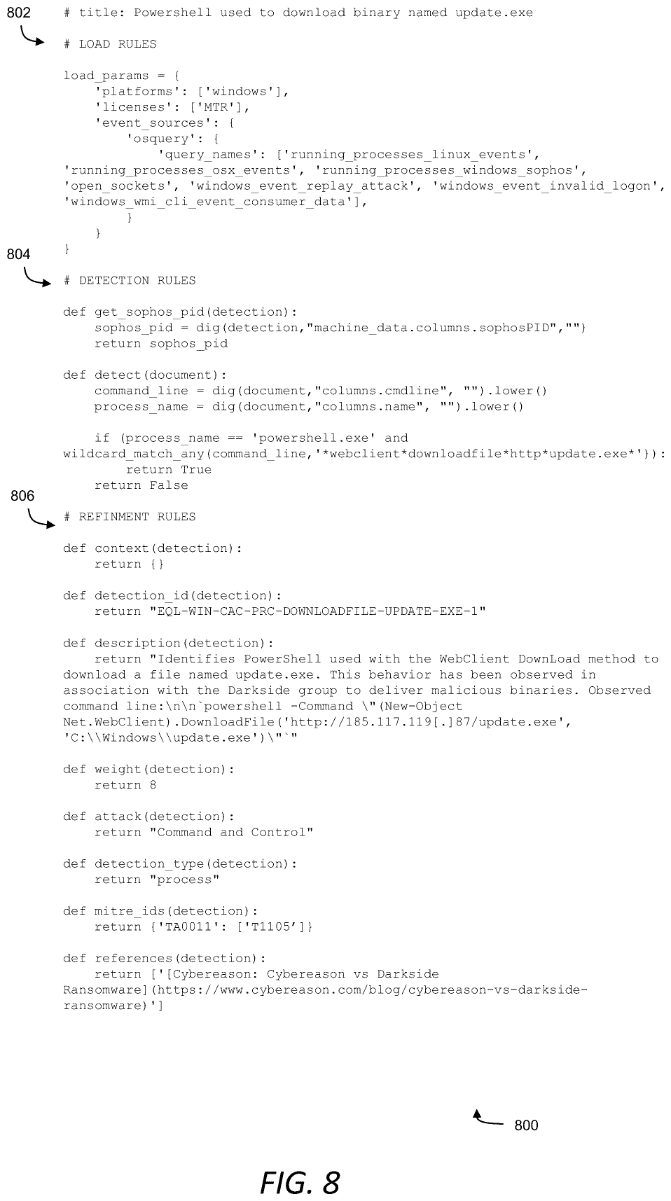

FIG. 8 illustrates a rule object. More specifically, FIG. 8 illustrates a rule object 800 coded in Skylark for use in detecting the use of a PowerShell to download a binary named “update.exe.” The rule object 800 may include one or more load rules 802 that specify parameters for when to apply a detection rule 804 in the rule object. For example, the load rules 802 may specify platforms (e.g., ‘Windows’) and other source information defining context(s) for when the rule object 800 should be executed to perform a detection. The detection rule 804 may generally specify programming logic for evaluating whether a detection should be made. For example, as illustrated in FIG. 8, the rule object 800 may include a detection rule 804 configured to search for the presence of “update.exe” in a PowerShell command line, and may return a value of True or False depending on whether a match is found in a search of the command line for the corresponding process. While illustrated as a single detection rule, it will be understood that the rule object 800 may include multiple detection rules, along with additional logic or the like to resolve compound or complex, multi-part detection rules into a single detection outcome.

The rule object 800 may also include a number of refinement rules 806 that provide additional information for reporting a detection. For example, the refinement rules 806 may include information concerning a detection identifier, a human-readable description and/or explanation, a severity or weight indicating a degree of threat, an attack type (“Command and Control”), a detection type (“process”), a MITRE identifier or other third-party identification number for the attack, a link or the like to additional information resources, and so forth. More generally, any information to assist in understanding, evaluating, and disposing of threats related to a detection, including information for a human analyst or automated threat response system, may usefully be included in the additional information provided by refinement rules 806.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as described herein.

What is claimed is:

1. A computer program product comprising computer executable code embodied in a non-transitory computer readable medium that, when executing on one or more computing devices associated with an enterprise network, causes the one or more computing devices to perform the steps of:
storing a plurality of rule objects for processing security events in an event stream of the enterprise network, wherein each one of the plurality of rule objects includes:
one or more detection rules for detecting malicious activities, and
one or more selection criteria for determining, based on a platform configuration for a source of a security event, whether to load the one or more detection rules of the one of the plurality of rule objects for use by an event processing service to evaluate the security event for potential malware;
receiving one of the security events in the event stream at the event processing service as a security event object;
determining the platform configuration for the source of the security event object;
selecting a group of rule objects including one or more of the plurality of rule objects based on the platform configuration for the source of the security event object;
applying each of the one or more detection rules from the group of rule objects to the security event object;
in response to identifying one of the malicious activities in the security event object with the one or more detection rules from the group of rule objects, generating a notification of malicious activity; and
transmitting the notification to a threat management facility for the enterprise network.

2. The computer program product of claim 1, wherein the platform configuration includes an operating system configuration for the source of the security event.

3. The computer program product of claim 1, wherein the platform configuration includes a software configuration for the source of the security event.

4. The computer program product of claim 1, wherein the source of the security event includes a compute instance associated with the enterprise network.

5. A method comprising:
storing a plurality of rule objects for processing events in an event stream of an enterprise network, wherein each one of the plurality of rule objects includes:
one or more detection rules for detecting activities, and
one or more load rules for determining whether to apply the one or more detection rules to the event stream;
receiving one of the events as an event object in the event stream;
determining a type of the event object;
selecting a first rule object from the plurality of rule objects based on the type of the event object;
applying a first detection rule from the first rule object to the event object; and
in response to identifying one of the activities in the event object with the first detection rule from the first rule object, initiating a response to the one of the activities.

6. The method of claim 5, wherein the type of the event object includes a source of the event object.

7. The method of claim 6, wherein the source of the event object includes a compute instance associated with the enterprise network.

8. The method of claim 6, wherein the source of the event object includes a firewall associated with the enterprise network.

9. The method of claim 5, wherein the type of the event object includes a platform configuration for a source of the event object.

10. The method of claim 9, wherein the platform configuration includes an operating system configuration for the source of the event object.

11. The method of claim 9, wherein the platform configuration includes a software configuration for the source of the event object.

12. The method of claim 5, wherein the one of the activities includes a malicious activity, and wherein initiating the response includes initiating a remediation of the malicious activity.

13. The method of claim 12, wherein initiating the remediation includes transmitting a notification of the malicious activity to a threat management facility for the enterprise network.

14. The method of claim 12, wherein initiating the remediation includes initiating a threat response to the malicious activity by a source of the event object.

15. The method of claim 12, wherein initiating the remediation includes at least one of quarantining a source of the event object, updating security software for the source of the event object, performing a scan of the source of the event object, and requesting data from a data recorder for a local security agent executing on the source of the event object.

16. The method of claim 5, wherein the event object includes a JSON object.

17. The method of claim 5, further comprising:
selecting a group of two or more of the rule objects from the plurality of rule objects based on the type of the event object; and
applying the one or more detection rules from the group of two or more of the rule objects to the event object.

18. A system for processing security events in an event stream for an enterprise network, the system comprising:
a database storing a plurality of rule objects for processing the security events in the event stream, wherein each one of the plurality of rule objects includes:
one or more detection rules for detecting malicious activities, and
one or more selection criteria for determining, based on a type of a security event, whether to apply the one or more detection rules of the rule object to the security event; and
a rule processing engine configured by computer executable code stored in a non-transitory computer readable medium that, when executing on one or more processors, causes the rule processing engine to perform the steps of:
receiving one of the security events as a security event object in the event stream,
determining the type of the security event object,
selecting a group of rule objects including one or more of the plurality of rule objects stored in the database based on the type,
applying each of the one or more detection rules for each rule object in the group of rule objects to the security event object,
in response to at least one of the detection rules identifying one of the malicious activities, generating a notification of a detection of malicious activity, and
transmitting the notification to a threat management facility for the enterprise network.

19. The system of claim 18, wherein the event stream includes a plurality of security event objects from a plurality of compute instances in the enterprise network managed by the threat management facility.

20. The system of claim 18, wherein each one of the plurality of rule objects includes one or more refinement rules that provide instructions for additional processing of one of the security events after the detection of the malicious activity is made based on the at least one of the detection rules.
